(19) United States
(12) Patent Application Publication
(10) Pub. No.: US 2012/0132629 A1
(43) Pub. Date: May 31, 2012

(54) METHOD AND APPARATUS FOR REDUCING TAPER OF LASER SCRIBES

(75) Inventors: James N. O'Brien, Bend, OR (US); Joseph G. Frankel, Beaverton, OR (US)

(73) Assignee: ELECTRO SCIENTIFIC INDUSTRIES, INC., Portland, OR (US)

(21) Appl. No.: 12/957,265

(22) Filed: Nov. 30, 2010

(51) Int. Cl. B23K 26/00

(52) U.S. Cl. 219/121.72; 219/121.67

(57) ABSTRACT

Methods and apparatuses for reducing taper of a laser scribe in a substrate are described. One method includes aiming a laser beam at a surface of the substrate in a first direction perpendicular to a first cutting direction of the beam and aiming it at the surface in a second direction perpendicular to the first cutting direction. In each position, the laser beam is tilted at a beam tilt angle with respect to a line perpendicular to the surface. A single scribe line is formed in the surface by applying the laser beam to the surface while aiming the laser beam in the first direction and cutting in the first cutting direction and applying the laser beam to the surface while aiming the laser beam in the second direction and cutting in one of the first cutting direction and a second cutting direction opposite the first cutting direction.

### TECHNICAL FIELD

The present invention relates in general to laser processing, particularly to a method and apparatus for reducing taper of laser scribes.

### BACKGROUND

Gaussian beam laser processing, when used for wafer scribing and other types of laser cutting, generally results in a tapered kerf. One solution to this problem is to use a shaped laser beam in the form of, for example a rectangular top hat. Such shaped beams still result in a certain amount of taper because the shaped laser beam does not have perfectly shaped sides.

### BRIEF SUMMARY

Embodiments of the invention reduce the taper in a kerf generated by laser processing or scribing. As mentioned above, typical laser processing results in a tapered kerf. That is, the bottom width of the kerf is less than the top width of the kerf at any given point along the cutting path. In contrast, embodiments of the invention incorporate strategic laser positioning to reduce taper of laser scribes or cuts. A straighter cut can reduce post-cut processing and maximizes the use of real estate in a substrate due to the predictability of the cuts.

One method of method of reducing taper of a laser scribe in a substrate taught herein comprises aiming a laser beam at a surface of the substrate in a first direction perpendicular to a first cutting direction of the laser beam and tilting the laser beam at a beam tilt angle with respect to a line extending perpendicular from the surface of the substrate, aiming the laser beam at the surface of the substrate in a second direction perpendicular to the first cutting direction of the laser beam and tilting the laser beam at the beam tilt angle with respect to the line extending perpendicular from the surface of the substrate, and forming a single scribe line in the surface of the substrate by applying the laser beam to the surface of the substrate while aiming the laser beam in the first direction and cutting in the first cutting direction and applying the laser beam to the surface of the substrate while aiming the laser beam in the second direction and cutting in one of the first cutting direction and a second cutting direction opposite the first cutting direction.

One exemplary apparatus for reducing taper of a laser scribe in a substrate comprises a laser, a chuck for supporting the substrate, beam steering optics configured to aim a laser beam from the laser at a surface of the substrate in a first direction perpendicular to a first cutting direction of the laser beam while tilting the laser beam at a beam tilt angle with respect to a line extending perpendicular from the surface of the substrate and configured to aim the laser beam at the surface of the substrate in a second direction perpendicular to the first cutting direction of the laser beam while tilting the laser beam at the beam tilt angle with respect to the line extending perpendicular from the surface of the substrate, and a controller. The controller is configured to form a single scribe line in the surface of the substrate by applying the laser beam to the surface of the substrate while aiming the laser beam in the first direction and cutting in the first cutting direction and applying the laser beam to the surface of the substrate while aiming the laser beam in the second direction and cutting in one of the first cutting direction and a second cutting direction opposite the first cutting direction.

Details of and variations in these embodiments and others are described in more detail below.

### BRIEF DESCRIPTION OF THE DRAWINGS

The description herein makes reference to the accompanying drawings wherein like reference numerals refer to like parts throughout the several views, and wherein:

FIG. 1 is a partial side view of a substrate including a kerf resulting from a square beam;

FIG. 2 is a schematic side view of a square beam in two positions according to teachings of the invention;

FIG. 3 is a top view of a path of the laser forming a single scribe line where the laser processing system incorporates dither;

FIG. 4 is a schematic drawing of a laser processing system for implementing the method described with respect to FIG. 3; and

FIG. 5 is a schematic drawing of a structure for modifying the laser processing system of FIG. 4 to obtain other embodiments of the invention; and

FIG. 6 is a schematic view of a possible modification to the structure of FIG. 5.

### DETAILED DESCRIPTION OF EMBODIMENTS OF THE INVENTION

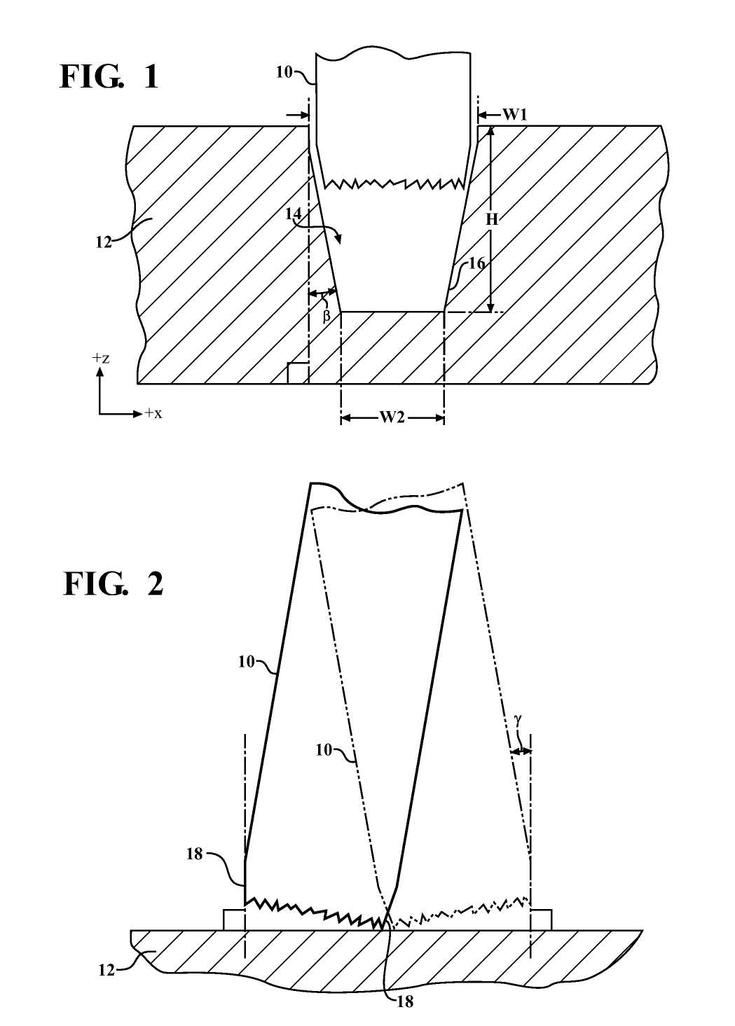

A unique method and apparatus to address the problem of taper resulting from laser scribing is initially explained with reference to FIGS. 1 and 2. A beam 10, here a square-shaped or square beam 10, penetrates a substrate 12 for a depth h. The resulting kerf 14 has a tapered side wall 16 such that a width w1 at the top of kerf 14 is wider than a width w2 at the bottom of kerf 14. For embodiments of this invention, the material of substrate 12 is not critical but it is generally non-metallic and/or brittle and can be comprised of a plurality of layers. Substrate 12 is also called workpiece 12 herein. Substrate 12 can be any size, but a relatively thick substrate 12 is about 500-800 μm, while a relatively thin substrate 12 is less than 100 μm.

Known techniques existing for making shaped beams such as square beams. For example, U.S. Patent Publication No. 2009/0245302 A1, published on Oct. 1, 2009, which is assigned to the Assignee of the present invention and is incorporated herein in its entirety by reference, describes methods and systems for dynamically generating tailored laser pulses. U.S. Pat. No. 6,433,301, issued on Aug. 13, 2002, which is also assigned to the Assignee and is incorporated herein in its entirety by reference, describes other methods and systems for shaping laser pulses. Note that in the typical profile of a square beam shown, an outer edge 18 of beam 10 is tapered. Accordingly, if beam 10 is repositioned so that each outer edge 18 is more perpendicular with substrate 12 as shown in FIG. 2, a straighter side wall 16 can be achieved. This is called beam tilt herein. As can be seen from FIG. 2, maintaining beam 12 at its same beam size while introducing beam tilt will increase the overall width of kerf 14 beyond the desired width w1 at the top of kerf 14. To achieve a specific kerf width, the beam size must be reduced according to the amount of tilt used to achieve the straighter side wall 16 as described in additional detail hereinafter. This technique of reducing taper in side wall 16 thus provides the added benefit of faster processing speeds as reducing beam size increases fluence. Although this invention is demonstrated with square beams 10, taper problems caused by beams 10 having other shapes can also be addressed with the teachings herein.

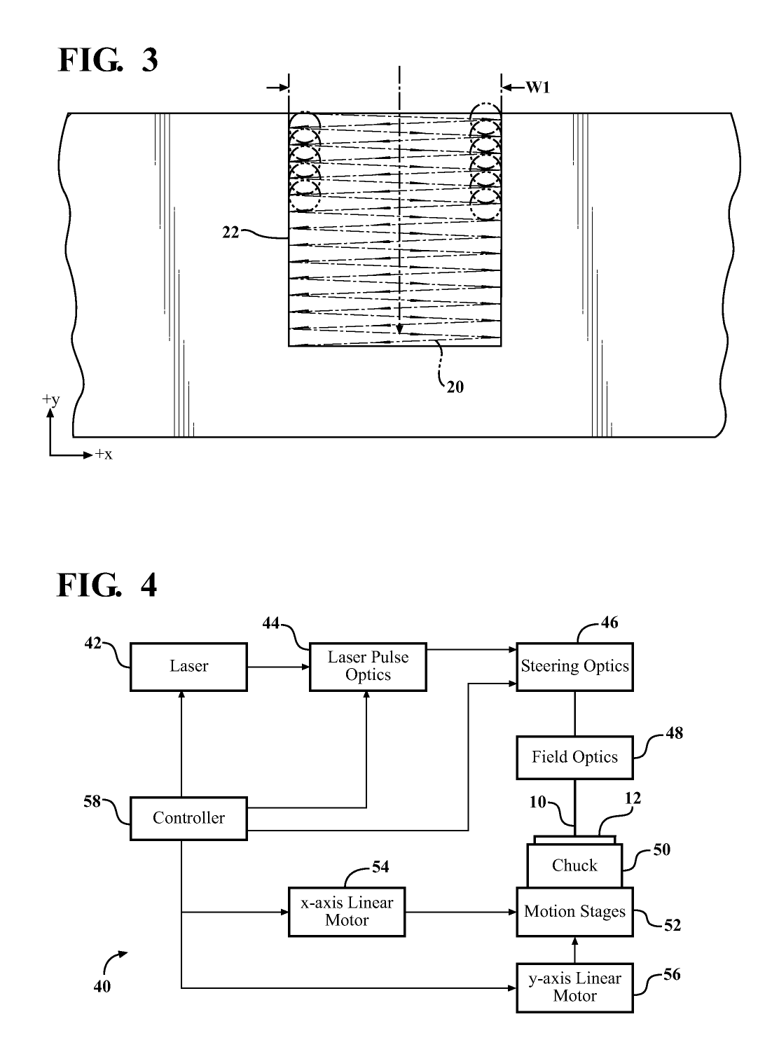

One way of positioning beam 10 to achieve the straighter side wall 16 using tilt involves applying a dithering technique as shown in FIG. 3. Dithering involves quickly moving beam 10 in a cross-axis direction while also moving in an on-axis direction. In FIG. 3, the arrow indicates the on-axis direction, which is also called the cutting direction. One possible path 20 for beam 10 is also shown. Note that the spacing between passes of path 20 are exaggerated, and generally the paths would vary little from pass to pass as beam 10 moves in the cutting direction either by its movement or by movement of substrate 12. The outer edges of path 20 define a resulting scribe line 22 of laser beam 10 in substrate 12. Scribe line 22 extends along the y-axis in this case.

FIG. 4 shows a laser processing system 40 that can be used to implement the method described with respect to FIG. 3. Laser processing system 40 has a laser 42, which may be a solid state, fiber laser or other laser, and depends on the application. Laser 42 emits pulses that are processed by laser pulse optics 44, which may be a simple optical component such as a lens or much more complex assemblies containing temporal and spatial beam shaping optics depending upon the laser parameters desired. In this example, a shaped beam is desired, so apertures and/or diffractive optics are included. The laser pulses are then directed by laser steering optics 46 through optional field optics 48 to substrate 12. Substrate 12 is supported on a chuck 50 attached to motion stages 52. In this example, motion stages 52 are controlled by an x-axis linear motor 54 and a y-axis linear motor 56.

Controller 58 controls laser 42, laser pulse optics 44, steering optics 46 and motion stages 52 through linear motors 54, 56 to direct pulsed laser beam 10 to workpiece or substrate 12. Controller 58 can be any controller, for example, a microcontroller that includes a central processing unit (CPU), random access memory (RAM), read only memory (ROM) and input/output ports receiving input signals and sending command signals to these components. The command signals are generally output based on programming instructions stored in memory, and the functions of each of the programming instructions are performed by the logic of the CPU. Various components could include their own controllers that transmit data to and from controller 58 as a main controller along a communication path. Moreover, controller 58 could be incorporated into a computer, such as a personal computer. Controller 58 could also be implemented by one or more microprocessors using external memory.

Any number of known designs can be used for motion stages 52. In this example, y-axis linear motor 56 moves chuck 50 along rails (not shown) oriented along the y-axis to make scribe line 22. To make a scribe line along the x-axis, x-axis linear motor 54 would move chuck 50 and the motion stage including the rails along rails (not shown) oriented along the x-axis. Instead of the arrangement described, a head supporting laser 42, laser pulse optics 44, steering optics 46 and field optics 48 could be mounted in a head movable along one of the x-axis and the y-axis (and optionally the z-axis), while a single motion stage 52 is configured to move in the other of the x-axis and the y-axis using, for example, a linear motor moving chuck 50 along rails. Another option is to mount a head supporting laser 42, laser pulse optics 44, steering optics 46 and field optics 48 so it is movable along each of the x-axis and the y-axis (and optionally the z-axis), while chuck 50 is mounted on a fixed base. Rotational movement can also be included in laser processing system 40.

Beam steering optics 46 generally includes galvanometers, fast steering minors, piezo-electric devices, electro-optical modulators, acousto-optical modulators and the like. Where beam positioning equipment such as beam steering optics 46 can provide relatively fast positioning, dithering as described with respect to FIG. 3 possible. For example, one embodiment of beam steering optics 46 can include two galvanometer-based scanners, commonly called “galvos,” arranged one each on the x- and y-axes. Each galvo includes three main components—the galvanometer, a minor (or mirrors) and a servo driver board that controls the system. Basically, the galvos are arranged along a respective axis and rotate their respective mirror(s) at a high speed from side to side, instead of spinning continuously in one direction, thus providing a side-to-side laser path. Galvos would tend to be useful in applications with a relatively large sweep and response times in the millisecond range. For small movement, such as movement below 100 μm with a response time in the order of μs, generally one or more acousto-optical deflectors are more preferable to effect dither.

Other embodiments are possible. For example, beam steering optics 46 could include a single minor that can be tilted about two axes by piezoelectric actuators as described in U.S. Patent Publication No. 2008/0093349 A1, published on Apr. 24, 2008, which is assigned to the Assignee of the present application and is incorporated herein in its entirety by reference. Such an embodiment would be slower than using galvos but would be more accurate at a sweep range between galvos and acousto-optical deflectors. When implementing an embodiment using dither, incorporating a small focusing, non-telecentric lens as field optics 48 is desirable.

The smaller the amount of beam tilt required, and hence the smaller the amount of dither required in this embodiment, the more difficult is the control. That is, for any actuator, the effective resolution will limit the ability to resolve small angles. For example, when a kerf width w1 is between 20-80 μm, and more particularly 40-45 μm or less, the amount of dither could be in the range of 2 μm depending on the laser used. Accordingly, introducing dither into the laser positioning may not be possible or desirable. In this case, positioning beam 10 to one side to cut in one direction and repositioning beam 12 to the other side to cut in the other direction as shown in FIG. 2 is possible. As in the embodiments including dither, the size of beam 10 would have to be reduced.

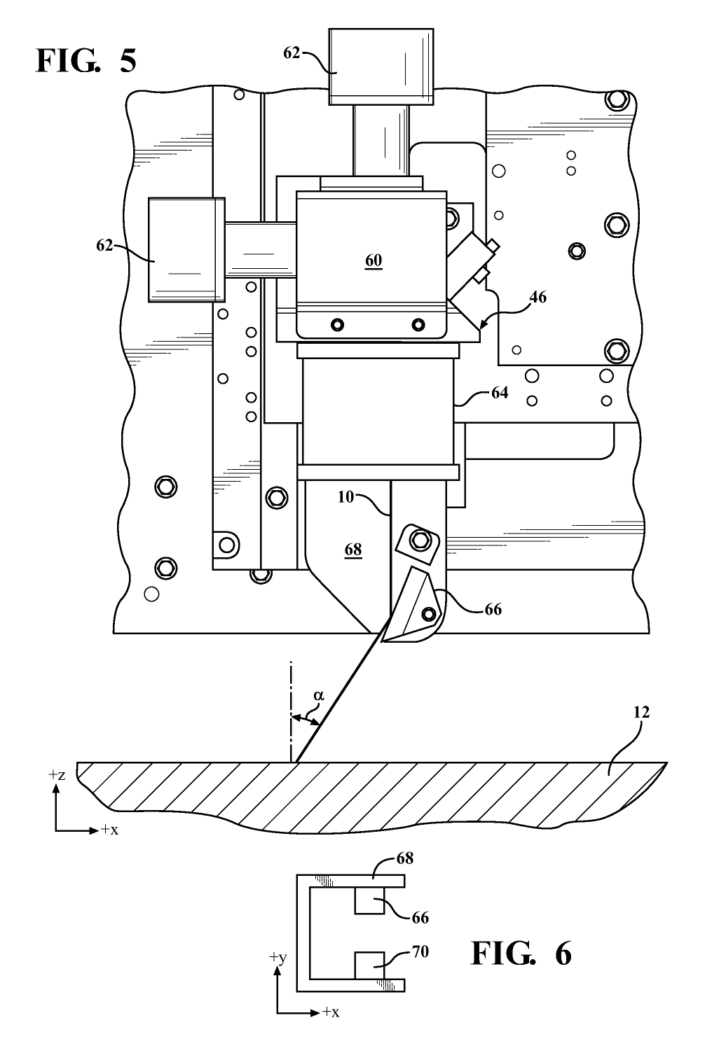

FIGS. 5 and 6 illustrate examples of an apparatus that can be used to implement this technique. In FIG. 5, steering optics 46 incorporates two galvos mounted for movement of their coupled mirrors along x- and z-axes within a housing 60 as described with respect to FIG. 4. Extending outside housing 60 is a galvo driver 62 for each of the two galvos. Instead of dithering as described previously, these galvos direct beam 10 through scan lens 64 to an adjustable tilt mirror 66. Scan lens 64 can desirably be a telecentric scan lens in this example. Focusing lens 60 in FIG. 4 is omitted in this embodiment. Tilt minor 66 aims beam 10 to substrate 12 so that the beam tilt is equal to angle α with respect to a perpendicular line extending from the plane of substrate 12. Although shown mounted to one side of its mounting assembly 68 and offset from the center of scan lens 64, tilt minor 66 could be centered in the arrangement. When beam 10 performs its first cut along the cutting direction, here along the y-axis, taper along the left side wall 16 with respect to FIG. 5 is minimized. For the second cut, several options are possible. Substrate 12 could be rotated 180 degrees by a motor controlled by controller 58. The beam tilt remains equal to angle α, and when beam 10 performs its second cut along the original cutting direction or in the opposite direction to speed processing, taper along the right side wall 16 with respect to FIG. 5 is minimized. Alternatively, tilt mirror 66 can be mounted for rotational movement about the axis defined by scan lens 64 such as by mounting assembly 68 for rotation. This rotational movement would be controlled by controller 58 or be performed by hand. Beam 10 is then re-directed to tilt minor 66 after rotation of assembly 68 by 180 degrees. While this option is possible, it may be less desirable to implement than moving substrate 12 because of the need to add the ability to rotate tilt minor 66. Further, the relative positions of substrate 12 and steering optics 46 and scan lens 64 along the x- and/or y-axes may require adjustment in order to form scribe line 22 with desired width w1.

While this embodiment is described as being useful with small tilt angles, it can also be used with relatively large tilt angles.

Another option to perform the second cut is to utilize a structure where assembly 68 is U-shaped as shown schematically in FIG. 6. In this example, assembly 68 supports a second tilt mirror 70 tilted to effect the same beam tilt angle α as tilt mirror 66 in the opposite leg of the U-shape. This arrangement may also require adjustment of the relative positions of substrate 12 and steering optics 46 and scan lens 64 along the x- and/or y-axes by, for example, x- and y-axis linear motors 54, 56 under control of controller 58, in order to form scribe line 22 with desired width w1.

Another possible structure that can implement a two-pass formation of scribe line 22 is similar to FIG. 5 except that assembly 68 is omitted. Deliberately aiming beam 10 from housing 60 by controlling galvo drivers 62 or other beam steering components in housing 60 to the non-linear region of scan lens 64 (e.g., the outer edge thereof) results in “tilting” beam 10 as it emerges from scan lens 64. Due to the small variations in beam tilt required in most applications, use of the scan lens 64 alone, where scan lens 64 is telecentric, may achieve the desired angles in combination with control by controller 58. When larger tilt angles are desired, a scan lens 64 that is non-telecentric can be incorporated so as to take advantage of the additional non-linearity of the resulting beam when passed through an edge of lens 64. Like the other embodiments, adjustment of the relative positions of substrate 12 and steering optics 46 and scan lens 64 along the x- and/or y-axes may be required in order to form scribe line 22 with desired width w1.

Angle α is the beam tilt needed so that an edge of beam 10 is more perpendicular with workpiece 12 so as to achieve straighter side walls 16 in kerf 14 as described with respect to FIG. 2. Angle α can be determined in more than one way for use in setting the range of dither or in setting the position of tilt mirror(s) 66, 70 relative to the other components of laser processing system 10. For example, and referring to FIG. 1, one exemplary method is to prepare a test scribe using the conventional beam 10 in a test substrate having the same properties as substrate 12. When referring to a test substrate herein, this also encompasses an unneeded portion of substrate 12. After preparing the test scribe, the slope of side wall 16 relative to the perpendicular line defined by a surface of the test substrate provides an angle β that is a good reference for angle α. Angle β does not exactly correlate to angle α the larger the angles are because of the change in the positioning of beam 10 with respect to the optics. Accordingly, determining angle α can be an iterative process where possible beam tilts are tested in the test substrate and adjusted based on the resulting taper if needed starting with angle β.

Another way of determining angle α is to analyze the beam profile for beam 10 either by imaging beam 10 or by mathematically modeling beam 10 so as to determine angle γ shown in FIG. 2. Angle γ is the angle at which outer edge 18 of beam 10 tapers off from the square shape defined by beam 10. Angle γ is more difficult to measure or calculate than angle β, but it can also provide a reference for angle α. Again, an iterative process may be required similar to that described above.

As previously mentioned, however much beam tilt is introduced, the size of beam 10 (more particularly its width) must be correspondingly decreased. The amount of decrease can be mathematically determined by the angle α, the depth h to which kerf 14 is to extend and the desired width w1 of kerf 14.

The above-described embodiments have been described in order to allow easy understanding of the present invention, and do not limit the present invention. On the contrary, the invention is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method of reducing taper of a laser scribe in a substrate, comprising:
aiming a laser beam at a surface of the substrate in a first direction perpendicular to a first cutting direction of the laser beam and tilting the laser beam at a beam tilt angle with respect to a line extending perpendicular from the surface of the substrate;
aiming the laser beam at the surface of the substrate in a second direction perpendicular to the first cutting direction of the laser beam and tilting the laser beam at the beam tilt angle with respect to the line extending perpendicular from the surface of the substrate; and
forming a single scribe line in the surface of the substrate by:
applying the laser beam to the surface of the substrate while aiming the laser beam in the first direction and cutting in the first cutting direction; and
applying the laser beam to the surface of the substrate while aiming the laser beam in the second direction and cutting in one of the first cutting direction and a second cutting direction opposite the first cutting direction.

2. The method of claim 1 wherein aiming the laser beam at the surface of the substrate in the first direction and aiming the laser beam at the surface of the substrate in the second direction comprise dithering the laser beam between the beam tilt angle in the first direction and the beam tilt angle in the second direction; and wherein forming the single scribe line in the surface of the substrate comprises cutting in only the first cutting direction.

3. The method of claim 1 wherein applying the laser beam to the surface of the substrate while aiming the laser beam in the second direction and cutting in one of the first cutting directing and a second cutting direction opposite the first cutting direction comprises applying the laser beam to the surface of the substrate while aiming the laser beam in the second direction and cutting in the first cutting direction.

4. The method of claim 1 wherein the beam tilt angle is an angle sufficient to result in a generally perpendicular sidewall for the single scribe line.

5. The method of claim 1, further comprising:
determining the beam tilt angle.

6. The method of claim 5 wherein determining the beam tilt angle comprises:
drilling a test scribe line in a surface of a test substrate using the laser beam, the laser beam aimed along a line extending perpendicular from the surface of the test substrate;
measuring a taper angle of a sidewall of the test scribe line; and
using the taper angle as the beam tilt angle in processing the substrate.

7. The method of claim 6, further comprising:
cutting a second kerf line in the surface of the test substrate while aiming the laser beam in at least one of the first direction or the second direction and tilting the laser beam at the taper angle with respect to the line extending perpendicular from the surface of the test substrate; and
adjusting the taper angle before using the taper angle as the beam tilt angle in processing the substrate, the adjusting based on an angle of a sidewall of the second kerf line.

8. The method of claim 5 wherein determining the beam tilt angle comprises:
determining a taper angle of the laser beam; and
basing the beam tilt angle on the taper angle.

9. The method of claim 1 wherein applying the laser beam to the surface of the substrate while aiming the laser beam in the first direction and cutting in the first cutting direction comprises maintaining the laser beam at the beam tilt angle with respect to the line extending perpendicular from the surface of the substrate while cutting in the first direction from a beginning of the single scribe line until reaching an end of the single scribe line, the method further comprising:
switching a position of the laser beam to aim the laser beam at the surface of the substrate in the second direction after reaching the end of the single scribe line; wherein applying the laser beam to the surface of the substrate while aiming the laser beam in the second direction and cutting in one of the first cutting direction and the second cutting direction comprises maintaining the laser beam at the beam tilt angle with respect to the line extending perpendicular from the surface of the substrate while cutting in the second direction from the end of the single scribe line until reaching the beginning of the single scribe line.

10. An apparatus for reducing taper of a laser scribe in a substrate, comprising:
a laser;
a chuck for supporting the substrate;
beam steering optics configured to aim a laser beam from the laser at a surface of the substrate in a first direction perpendicular to a first cutting direction of the laser beam while tilting the laser beam at a beam tilt angle with respect to a line extending perpendicular from the surface of the substrate and configured to aim the laser beam at the surface of the substrate in a second direction perpendicular to the first cutting direction of the laser beam while tilting the laser beam at the beam tilt angle with respect to the line extending perpendicular from the surface of the substrate; and
a controller configured to form a single scribe line in the surface of the substrate by:
applying the laser beam to the surface of the substrate while aiming the laser beam in the first direction and cutting in the first cutting direction; and
applying the laser beam to the surface of the substrate while aiming the laser beam in the second direction and cutting in one of the first cutting direction and a second cutting direction opposite the first cutting direction.

11. The apparatus of claim 10, further comprising:
a linear motor mechanically coupled to the chuck; wherein the controller is configured to form the single scribe line by controlling the linear motor to move along an axis defined by the first cutting direction and the second cutting direction.

12. The apparatus of claim 10 wherein the beam steering optics comprises at least one galvometer.

13. The apparatus of claim 10 wherein the beam steering optics comprises:
a housing supporting beam steering components;
an assembly supporting a tilt mirror;
a scan lens mounted on the housing between the housing and the assembly, the beam steering components configured to direct the laser beam from the laser to the scan lens and the tilt minor angled so as to direct the laser beam from the scan lens to the substrate.
